(19) United States
(12) Patent Application Publication
(10) Pub. No.: US 2015/0142944 A1
(43) Pub. Date: May 21, 2015

(54) INFORMATION PROCESSING APPARATUS, INFORMATION PROVISIONING METHOD AND INFORMATION DISPLAY SYSTEM

(71) Applicant: Masako KANEYASU, Tokyo (JP)

(72) Inventor: Masako KANEYASU, Tokyo (JP)

(73) Assignee: Ricoh Company, Ltd., Tokyo (JP)

(21) Appl. No.: 14/538,834

(22) Filed: Nov. 12, 2014

(30) Foreign Application Priority Data
Nov. 21, 2013 (JP) 2013-240517

(51) Int. Cl. H04L 29/06

(52) U.S. Cl. CPC H04L 65/605
USPC 709/223

(57) ABSTRACT

An information processing apparatus connectable to one or more terminal devices via a network includes a management unit that associates information which is required to be displayed on a terminal device with a setting of whether the information is allowed to be stored in a storage unit included in the terminal device; and a provisioning unit that adds to the information a specification indicating that the information is not allowed to be stored in the storage unit included in the terminal device and provides the information to the terminal device which requires the information, when the setting associated with the information to be displayed on the terminal device indicates that the information is not allowed to be stored in the storage unit included in the terminal device.

### BACKGROUND OF THE INVENTION

1. Field of the Invention

The disclosures herein generally relate to an information processing apparatus, an information provisioning method and an information display system.

2. Description of the Related Art

Conventionally, an information provisioning system including plural mobile terminals and a server wherein the server has a download unit that causes all the plural mobile terminals to download a document and a forcible discard unit that causes all the plural mobile terminals to discard the document when the provisioning of the document ends has been known (See, for example, Japanese Published Patent Application No. 2012-123736).

### SUMMARY OF THE INVENTION

It is a general object of at least one embodiment of the present invention to provide an information processing apparatus, an information provisioning method and an information display system that substantially obviates one or more problems caused by the limitations and disadvantages of the related art.

In one embodiment, an information processing apparatus is connectable to one or more terminal devices via a network. The information processing apparatus includes a management unit that associates information which is required to be displayed on a terminal device with a setting of whether the information is allowed to be stored in a storage unit included in the terminal device; and a provisioning unit that adds to the information a specification indicating that the information is not allowed to be stored in the storage unit included in the terminal device and provides the information to the terminal device which requires the information, when the setting associated with the information to be displayed on the terminal device indicates that the information is not allowed to be stored in the storage unit included in the terminal device.

In another embodiment, an information provisioning method is executed in an information processing apparatus connectable to one or more terminal devices via a network. The method includes associating information which is required to be displayed on a terminal device with a setting of whether the information is allowed to be stored in a storage unit included in the terminal device; and adding to the information a specification indicating that the information is not allowed to be stored in the storage unit included in the terminal device and providing the information to the terminal device which requires the information, when the setting associated with the information to be displayed on the terminal device indicates that the information is not allowed to be stored in the storage unit included in the terminal device.

In yet another embodiment, an information display system includes an application installed on one or more terminal devices and an information processing apparatus connected to the terminal device via a network. The display system further includes a management unit that associates information which is required to be displayed on the application with a setting of whether the information is allowed to be stored in a storage unit included in a terminal device; a provisioning unit that adds to the information a specification indicating that the information is not allowed to be stored in the storage unit included in the terminal device and provides the information to the application which requires the information, when the setting associated with the information to be displayed on the application indicates that the information is not allowed to be stored in the storage unit included in the terminal device; and a display control unit that displays the provided information without storing the information in the storage unit included in the terminal device, when the information which specifies that the information is not allowed to be stored in the storage unit included in the terminal device is provided.

According to the present embodiment, an information processing apparatus, an information provisioning method and an information display system that can inhibit leaking of information are provided.

### BRIEF DESCRIPTION OF THE DRAWINGS

Other objects and further features of embodiments will be apparent from the following detailed description when read in conjunction with the accompanying drawings.

FIG. 1 is a configuration diagram illustrating an example of a conference system according to a present embodiment;

FIG. 2 is a hardware configuration diagram illustrating an example of a computer included in the conference system according to the present embodiment;

FIG. 3 is a functional block diagram illustrating an example of the conference system according to the present embodiment;

FIG. 4 is a configuration diagram illustrating an example of a conference information table according to the present embodiment;

FIG. 5 is a configuration diagram illustrating an example of a document information table according to the present embodiment;

FIG. 6 is a flowchart illustrating an example of a process of conference registration according to the present embodiment;

FIG. 7 is a diagram illustrating an example of a screen for conference registration in a conference application according to the present embodiment;

FIG. 8 is a diagram illustrating an example of a list of conference screens according to the present embodiment;

FIG. 9 is a flowchart illustrating an example of a process of sending/receiving an image file of a conference document according to the present embodiment;

FIG. 10 is a diagram illustrating an example of a conference screen according to the present embodiment;

FIG. 11 is a diagram illustrating an example of image files of a conference document for a standard display and for an enlarged display set respectively at IMG tags in an HTML (hypertext markup language) file according to the present embodiment; and

FIG. 12 is a flowchart illustrating an example of a process of an enlarged/reduced display for an image of the image file of the conference document according to the present embodiment.

### DESCRIPTION OF THE PREFERRED EMBODIMENTS

In the following, embodiments of the present invention will be described with reference to the accompanying drawings. Meanwhile, in the present embodiment, a conference system which is an example of an information display system will be explained. However, the present invention is not limited to the conference system, but may be an information processing system that displays information.

### First Embodiment

### System Configuration

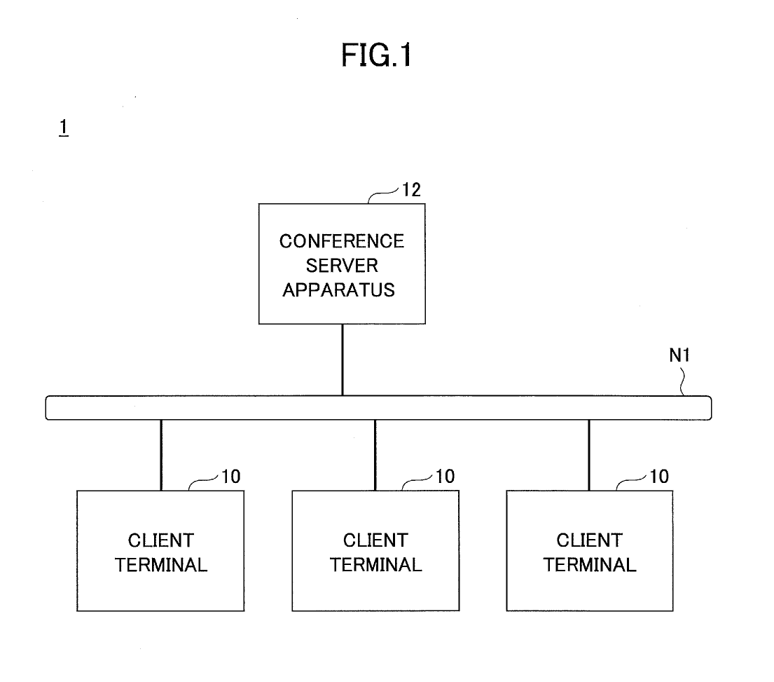

FIG. 1 is a configuration diagram illustrating an example of the conference system according to the present embodiment. The conference system 1 in FIG. 1 shows as an example configuration in which plural client terminals 10 and a conference server apparatus 12 are communicably connected with each other by wire or wirelessly via a network N1 such as a LAN (Local Area Network).

The client terminal 10 is a terminal device that a user operates. The client terminal 10 includes, for example, a desktop personal computer, a notebook computer, a tablet-type terminal, a smartphone, a mobile phone, a projector or the like. The client terminal 10 can access the conference server apparatus 12. The client terminal 10 receives (downloads) an image of conference document from the conference server apparatus 12, as described later, and performs a synchronous/asynchronous display of the image of conference documents or the like.

The conference server apparatus 12 is realized by one or more computers. For example, the conference server apparatus 12 may take a form of a so-called “cloud service”. The conference server apparatus 12 performs an information process related to a conference. Moreover, the conference server apparatus 12 performs a transmission of the image of the conference documents to the client terminal 10 or the like. Meanwhile, the conference server apparatus 12 is a WS (Workstation), a PC (personal computer) or the like. The conference server apparatus 12 saves conference information, the image of conference document or the like registered from the client terminal 10 or the like.

For example, the conference server apparatus 12 accommodates an HTML (Hypertext Markup Language) document, a CSS (Cascading Style Sheets) file, a JavaScript (trademark registered) file, an image file or the like. The JavaScript file is an example of a file described in a script language (simplified programming language). The conference server apparatus 12 is responsible for managing of conferences, including drafting, editing, removing or searching a conference, or necessary communication for the respective client terminals 10 during the conference.

<Hardware configuration>

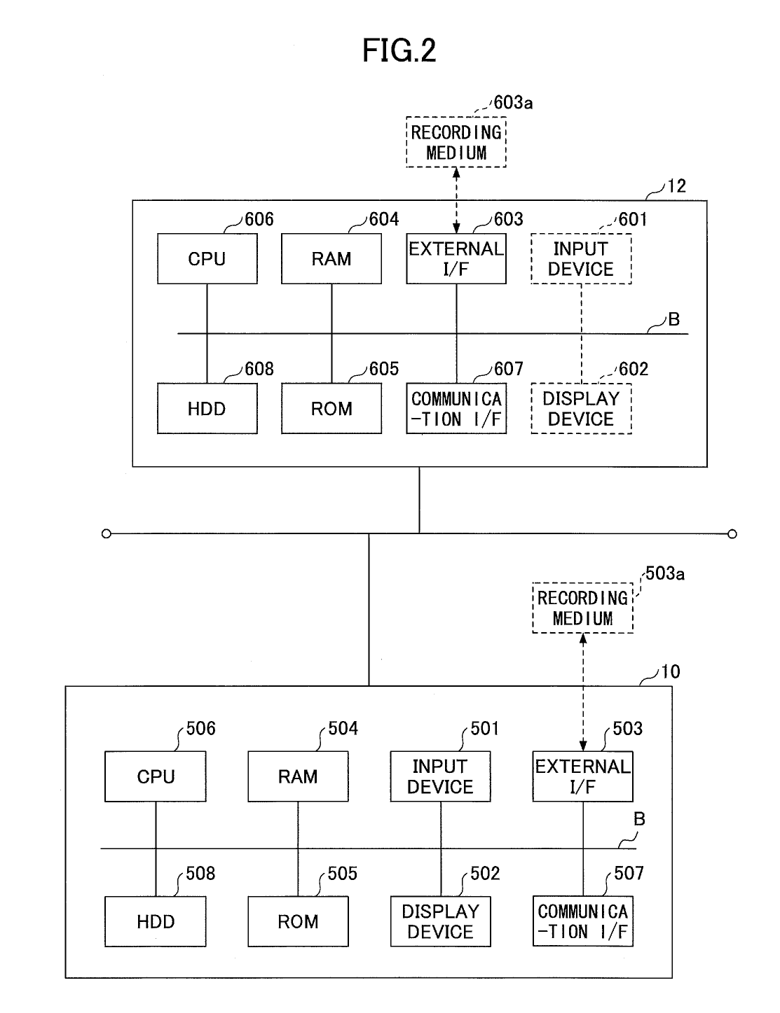

The client terminal 10 and the conference server apparatus 12 are realized by a hardware configuration as shown in FIG. 2, for example.

FIG. 2 is a hardware configuration illustrating an example of a computer included in the conference system according to the present embodiment. The client terminal 10 includes an input unit 501, a display unit, an external I/F 503, a RAM (random access memory) 504, a ROM (read-only memory) 505, a CPU (central processing unit) 506, a communication I/F 507, an HDD (hard disk drive) 508 and the like, which are connected with each other via a bus B.

The input unit 501 includes a keyboard, a mouse, a touch panel or the like, and is used for inputting respective operation signals into the client terminal 10. The display unit 502 includes a display device or the like, and displays a result of a process by the client terminal 10. The communication I/F 507 is an interface that connects the client terminal 10 to a network N1. Accordingly, the client terminal 10 can perform data communication with the conference server apparatus 12 via the communication I/F 507.

The HDD 508 is a non-volatile storage device that stores programs or data. The programs or the data stored in the HDD 508 include an OS (operating system), which is basic software for controlling the whole client terminal 10, application software for providing various functions on the OS, or the like.

The external I/F 503 is an interface to an external device. The external device includes a recording medium 503a or the like. Accordingly, the client terminal 10 can perform a read or write to the recording medium 503a via the external I/F 503. The recording medium 503a includes a flexible disk, a CD (compact disk), a DVD (digital versatile disk), a SD (secure digital) memory card, a USB (universal serial bus) memory or the like.

The ROM 505 is a non-volatile semiconductor memory (storage device) which can retain programs or data even if power is turned off. In the ROM 505, programs or data such as a BIOS (Basic Input/Output system), an OS setting, a network setting and the like, which are executed at the time of startup of the client terminal 10, are stored. The RAM 504 is a volatile semiconductor memory that temporarily retains programs or data.

The CPU 506 is an arithmetic device that realizes the control of the whole client terminal 10 or the functions by reading out programs or data from the storage device, such as the ROM 505, the HDD 508, or the like, onto the RAM 504, and executing processes.

The client terminal 10 can realize various processes, which will be described later, by executing programs in the above hardware configuration, for example.

The conference server apparatus 12 shown in FIG. 2 is provided with an input unit 601, a display unit 602, an external I/F 603, a RAM 604, a ROM 605, a CPU 606, a communication I/F 607, a HDD 608 and the like, which are connected with each other via a bus B. Meanwhile, the input unit 601 and the display unit 602 may take a form where they are connected when needed and used.

The input unit 601 includes a keyboard, a mouse or the like, and is used for inputting respective operation signals into the conference server apparatus 12. The display unit 602 includes a display device or the like, and displays a result of a process by the conference server apparatus 12. The communication I/F 607 is an interface that connects the conference server apparatus 12 to the network N1. Accordingly, the conference server apparatus 12 can perform data communication with the client terminal 10 via the communication I/F 607.

The HDD 608 is a non-volatile storage device that stores programs or data. The programs or the data stored in the HDD 608 include an OS, which is basic software for controlling the while conference server apparatus 12, application software for providing various functions on the OS, or the like.

The external I/F 603 is an interface to an external device. The external device includes a recording medium 603a or the like. Accordingly, the conference server apparatus 12 can perform a read out or a write into the recording medium 603a via the external I/F 603. The recording medium 603a includes a flexible disk, a CD, a DVD, a SD memory card, a USB memory or the like.

The ROM 605 is a non-volatile semiconductor memory (storage device) which can retain programs or data even if power is turned off. In the ROM 605, programs or data such as a BIOS, an OS setting, a network setting and the like, which are executed at the time of startup of the conference server apparatus 12, are stored. The RAM 604 is a volatile semiconductor memory that temporarily retains programs or data.

The CPU 606 is an arithmetic device that realizes the control of the whole conference server apparatus 12 or the functions by reading out programs or data from the storage device, such as the ROM 505, the HDD 508 or the like, onto the RAM 604, and executing processes.

The conference server apparatus 12 can realize various processes, which will be described later, by executing programs in the above hardware configuration, for example.

<Software Configuration>

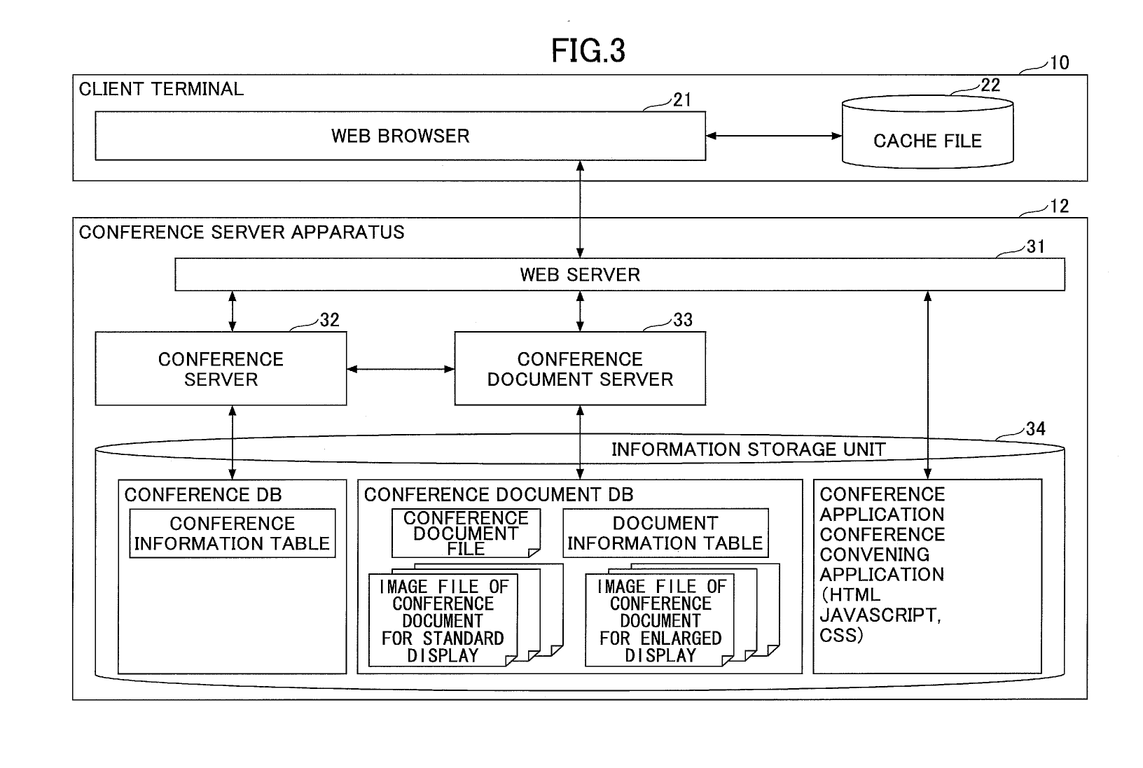

The conference system 1 according to the present embodiment is realized by the functional block as shown in FIG. 3, for example. FIG. 3 is a functional block diagram illustrating an example of the conference system according to the present embodiment. Here, the conference system 1 in which the conference server apparatus 12 uses an instant messenger using the XMPP (Extensible Messaging and Presence Protocol), and performs communication with the client terminal 10 will be explained as an example.

Meanwhile, the XMPP has been standardized at the IETF (Internet Engineering Task Force) by RFC 3920 (Extensible Messaging and Presence Protocol: Core) and RFC 3921 (Extensible Messaging and Presence Protocol: Instant Messaging and Presence), and the extended specification has been documented as XEP (XMPP Extension Protocol).

The XMPP can provide a service of a group chat (Multi-User Chat [XEP-0045]). The group chat is a function of, when a message is sent from a client terminal 10 participating in a conference room (room) provided by the XMPP to a conference server apparatus 12, distributing the message to all client terminals participating in the room.

Moreover, the XMPP also has a skill of sending/receiving a message in the HTTP (hypertext transfer protocol), i.e. BOSH (Bidirectional-streams Over Synchronous HTTP) [XEP-0206]. By using the BOSH, the conference server apparatus 12 can perform XMPP communication in the HTTP. Furthermore, the conference server can also realize a Push function. The Push function is a function of transmitting information from the conference server apparatus 12 to the client terminal 10 and receiving the information at the client terminal 10, not transmitting information required from the client terminal 10.

The client terminal 10 has a WEB browser 21. Moreover, the client terminal 10 realizes a cache file storage unit 22 by the HDD 508. The conference server apparatus 12 realizes a WEB server 31, a conference server 32, a conference document server 33 and an information storage unit 34 by executing a program. In the information storage unit 34, a conference DB, a conference document DB, a conference application, a conference convening application or the like is stored.

In the conference DB, a conference information table, which will be described later, is stored. In the conference document DB, a document information table, which will be described later, a conference document file, image files of a conference document for a standard display and an enlarged display converted from an image in the conference document file are stored.

For example, the WEB server 31 is provided with an information transmission/reception function or the like. Moreover, the conference server 32 is provided with a conference management function or the like. The conference document server 33 is provided with a conference document management function, an image conversion function or the like.

The conference server 32 reflects a request for drafting a conference, a request for editing or a request for removing sent from the respective client terminals 10 to the conference information table in the conference DB. Moreover, the conference server 32 processes a request for convening, participating, exiting or ending sent from the client terminals 10. During the conference, the conference server 32 manages conference sharing information, including a displayed conference document, a displayed page of the conference document, handwritten memo data or the like. Moreover, a request from the client terminal 10 to the conference server 32 is performed by a message using the XMPP.

The conference document server 33, based on a registration request for a conference document file from the respective client terminals 10, stores the conference document file in the conference document DB, and reflects it to the document information table. The conference document server 33 converts the conference document file stored in the conference document DB into image files of a conference document for the standard display and for the enlarged display, which will be described later. Moreover, the conference document server 33, based on an acquisition request for the image file of the conference document sent from the respective client terminals 10, transmits the image file of a conference document to the client terminals 10, as described later.

In the information storage unit 34, the conference application or the conference convening application which is executed on the WEB browser 21 installed in the client terminal 10 and will be described later is stored. The conference application or the conference convening application is realized, for example, by a HTML file (HTML document) displayed on the WEB browser 21, a CSS file associated with it, a JavaScript file, an image file or the like. The conference application or the conference convening application is downloaded from the conference server apparatus 12 to the client terminal 10 and is used.

Moreover, the conference system 1, by using the Ajax (Asynchronous JavaScript XML) technology, can operate a DOM (Document Object Model) and rewrite content displayed on the WEB browser 21. The Ajax technology is a form of implementation in which a process is performed by transferring XML data without reloading Web pages by using the HTTP communication function of a JavaScript file.

Meanwhile, a method of rewriting the content displayed on the WEB browser 21 is not limited to the method of updating a DOM. For example, in “HTML5”, the content displayed on the WEB browser 21 can be directly rewritten.

The conference system 1 uses a WEB server 31 so that the WEB browser 21 in the client terminal 10 communicates with the conference server 32. Moreover, as a means for uploading a conference document file or for downloading an image file of a conference document, the XMPP message is unsuitable for communicating a binary file of large size. Therefore, the conference system 1, using a GET request or a POST request in the HTTP, uploads the conference document file or downloads the image file of the conference document.

Moreover, in the conference system 1, in response to a user's input (operation) such as a selection of a conference document file, a display page of the conference document file or the like, XML data are generated in JavaScript, and sent to the conference server apparatus 12 from the client terminal 10 by the group chat.

The conference server apparatus 12 distributes the XML data to all the client terminals 10 participating in the conference room. The conference application which operates on the WEB browser 21 in the client terminal 10 interprets the XML data, and receives image files of a conference document for a standard display and for an enlarged display corresponding to a display page of the conference document file from the conference server apparatus 12.

The conference convening application which operates on the WEB browser 21 in the client terminal 10, for example, by operating (updating) the DOM, as described later, can display the image files of the conference document for the standard display and for the enlarged display corresponding to the display page of the conference document file by switching. Moreover, the conference convening application, by operating (updating) the DOM, can update a display of a text, a diagram, a handwritten memo or the like drawn on the displayed image of conference document.

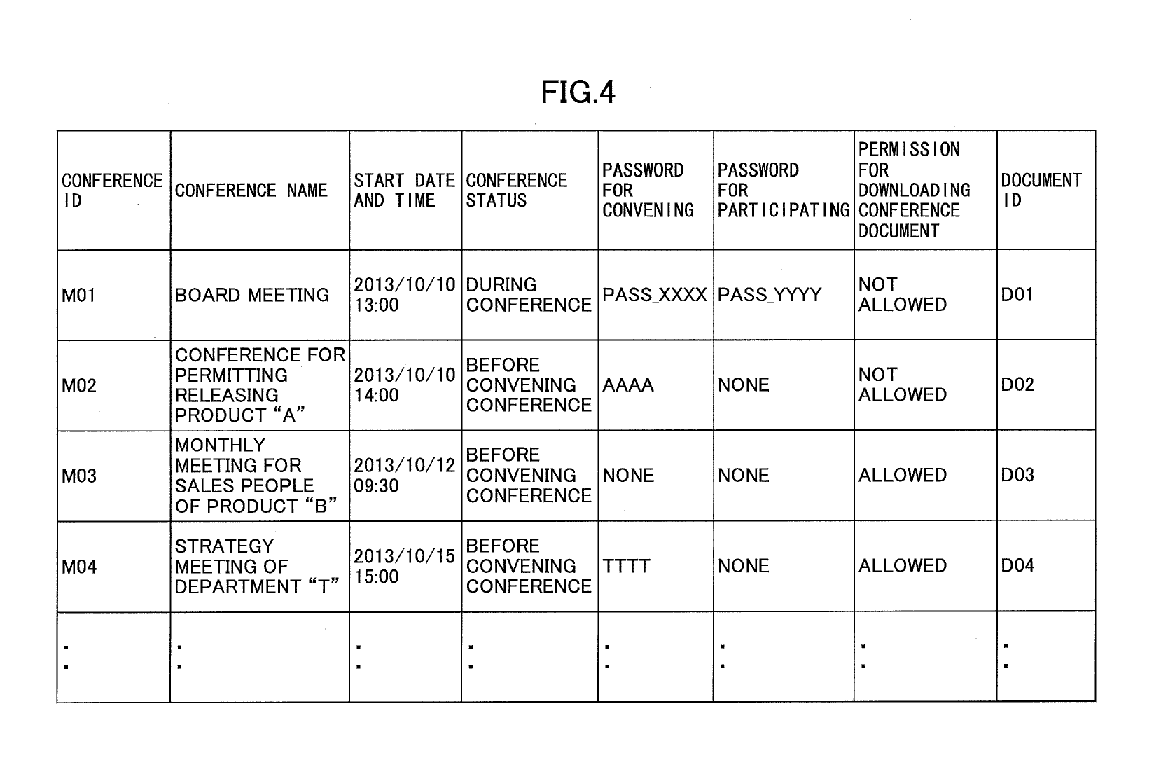

FIG. 4 is a configuration diagram illustrating an example of the conference information table. The conference information table includes as items a conference ID, a conference name, a start date and time, a conference status, a password for convening, a password for participating, a permission for downloading conference documents, a document ID or the like.

The conference ID is information for uniquely identifying a conference set by the conference server 32 in response to a creation request for conference from the client terminal 10 so as to be unique. The conference name is arbitrarily set by a user, and used for identifying the conference by the user. The start date and time is arbitrarily set by a user, and used for identifying the conference by the user, such as a scheduled time for starting the conference.

The conference status indicates one of three statuses, before convening the conference, during conference and after convening the conference. The conference status is an item that the conference server 32 sets, and is changed by the conference server 32 depending on the situation. When a conference is newly created, the conference status is set “before convening conference”. When the conference is convened, the conference status is changed to “during conference”. When all users who participated in the conference exit and the conference ends, the conference status is changed to “after convening conference”.

The password for convening is authentication information used for convening a conference. The password for participating is authentication information used for participating in the conference. In the case where the password for participating is set, a user cannot participate in the conference if he/she does not know the password for participating. The permission for downloading conference documents is information of whether to permit a cache for the downloaded image file of the conference document in a cache file storage unit 22, for example, allowed/not allowed. The document ID is identification information that can identify the conference document file used in the conference or the image file of the conference document.

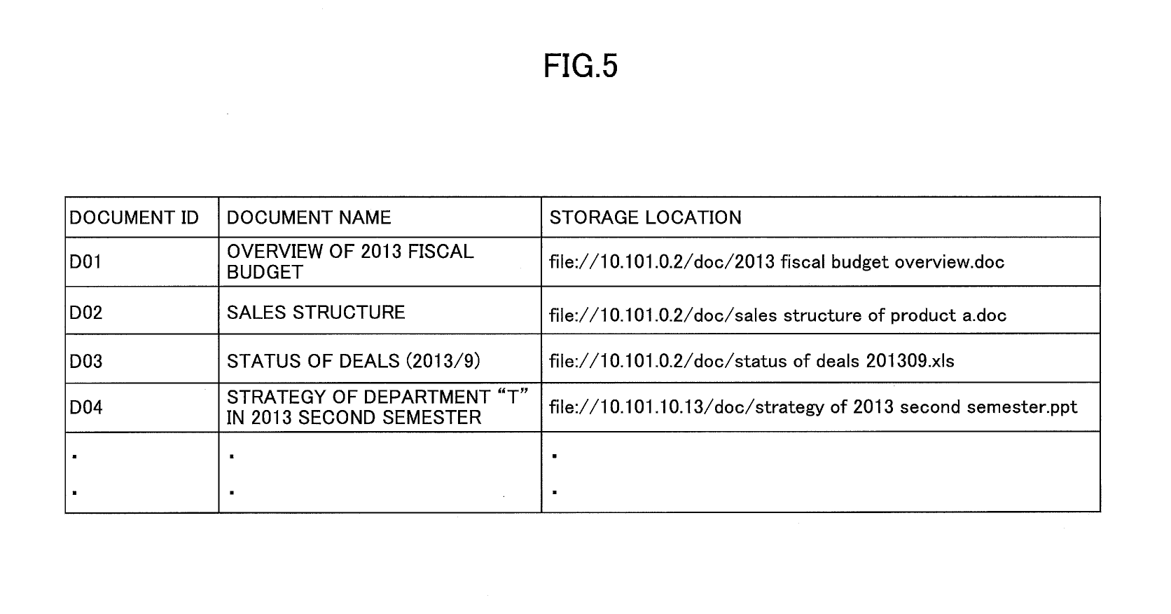

FIG. 5 is a configuration diagram illustrating an example of the document information table. The document information table includes as items a document ID, a document name, a storage location or the like. The document ID is identification information that can identify the conference document file used in the conference or the image file of the conference document. The document name is arbitrarily set by a user, and used for identifying the conference document file by the user. The storage location indicates the storage location of the conference document file.

<Detailed Process>

In the following, a process of the conference system 1 according to the present embodiment will be explained in detail.

<<Conference Registration Process>>

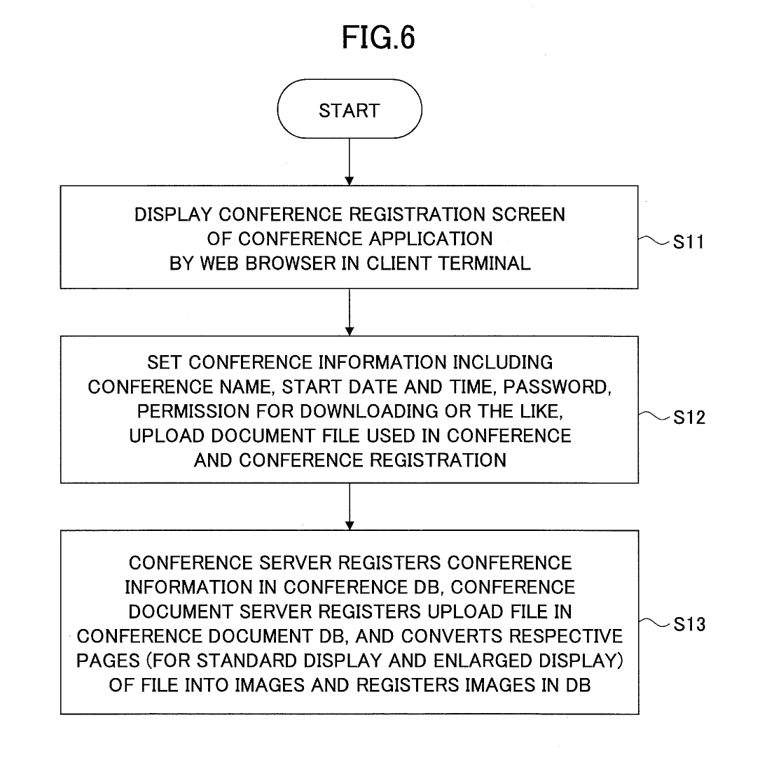

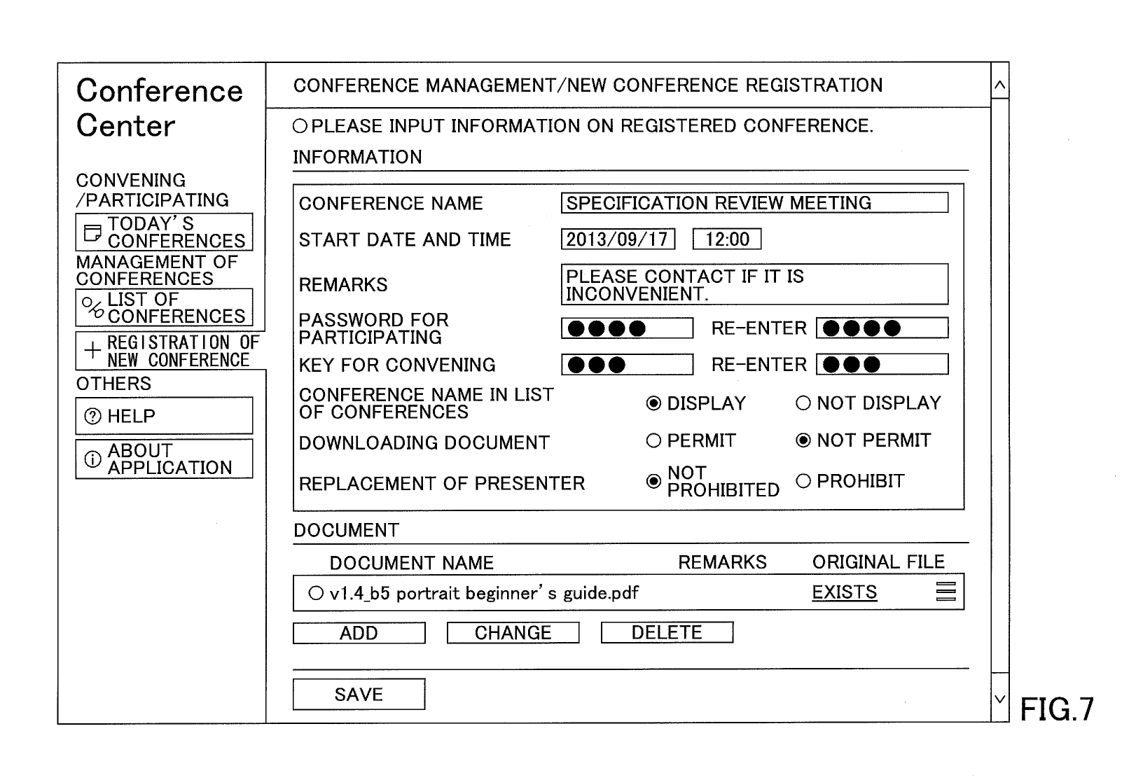

FIG. 6 is a flowchart illustrating an example of a conference registration process. At step S11, a presenter, the organizer or the like of the conference, prior to the convening of the conference, display a conference registration screen in the conference application, as shown in FIG. 7, from the WEB browser 21 in the client terminal 10 by accessing a predetermined URL.

FIG. 7 is a diagram illustrating an example of the conference registration screen in the conference application. The conference registration screen in FIG. 7 is a screen on which a registration of conference information or a registration of a conference document file to be displayed (viewed) in the conference is performed. The conference registration screen is a screen for registering conference information, including a conference name, a start date and time as a date and time for convening, remarks, a password for participating, a convening key as a password for convening, a setting whether to display or not display the conference name in a conference list, which will be described later, and a setting whether a presenter is allowed to be replaced. Furthermore, the conference registration screen in FIG. 7 is a screen for performing a setting whether to permit downloading a document as information whether to permit a cache for the downloaded image file of the conference document in a cache file storage unit 22.

At step S12, the presenter, the organizer or the like of the conference sets the conference information and the conference document file on the conference registration screen in FIG. 7, and, for example, holds down a “save” button, to instruct a registration of the conference information and the conference document file. The conference application which operates on the WEB browser 21 in the client terminal 10 requires the conference server apparatus 12 to register the conference information and the conference document file which is set by the presenter, the organizer or the like of the conference.

At step S13, the WEB server 31 in the conference server apparatus 12 diverts a registration request for conference information from the client terminal 10 to a conference server 32, and diverts a registration request for the conference document file to a conference document server 33.

The conference server 32, based on the registration request for conference information from the client terminal 10, registers the conference information in the conference information table in FIG. 4. Moreover, the conference document server 33, based on the registration request for conference document files from the client terminal 10, registers the conference document files in the conference document DB and reflects information of the conference document files to the document information table shown in FIG. 5.

Afterwards, the conference document server 33 converts respective pages of the conference document files stored in the conference document DB into image files of a conference document for a standard display and for an enlarged display, which will be described below, and registers them in the conference document DB. That is, in the conference document DB, the image files of the conference documents for the standard display and for the enlarged display of the respective pages of the conference document files are stored.

<<Conference convening process>>

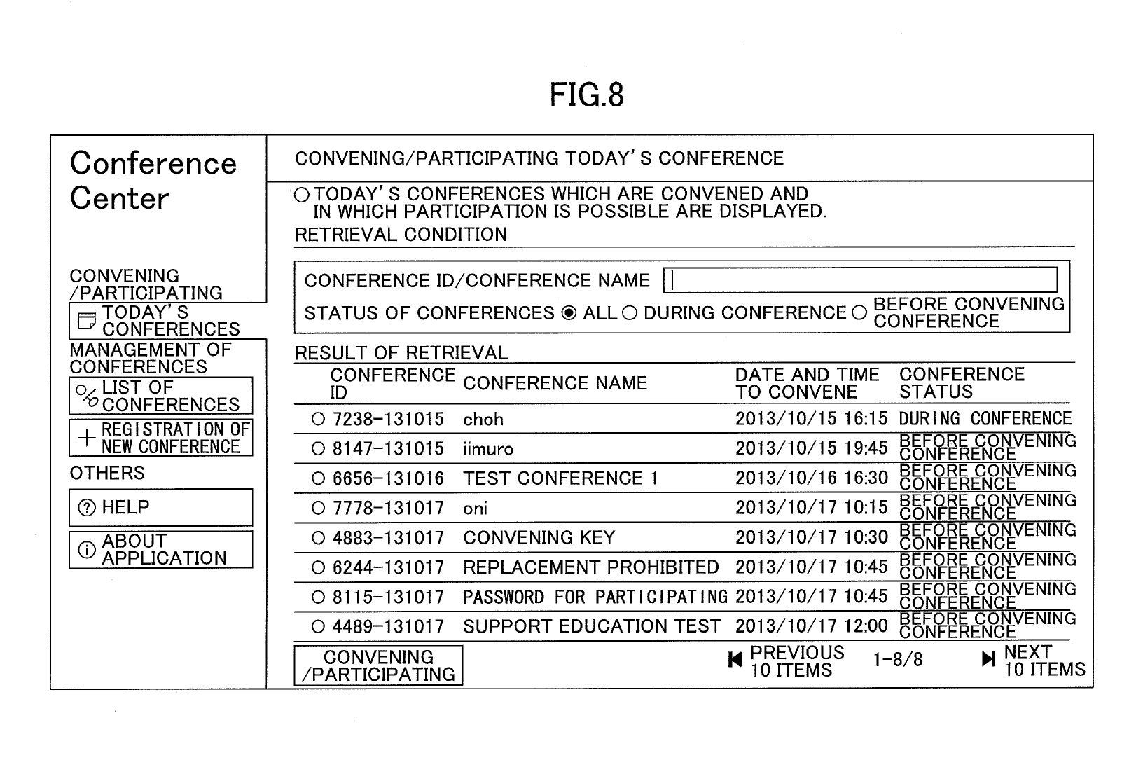

The presenter, the organizer or the like of the conference, by selecting “Today's conferences” in the conference registration screen in FIG. 7, causes the WEB browser 21 in the client terminal 10 to display a conference list screen shown in FIG. 8. FIG. 8 is a diagram illustrating an example of the conference list screen. The conference list screen in FIG. 8 is a screen that displays a list of conference registered in the conference information table in the conference server apparatus 12, and causes a user to select a conference which the user convenes or participates in. Meanwhile, the conference application that operates on the WEB browser 21 in the client terminal 10 acquires conference information from the conference server apparatus 12 and displays the conference list screen.

The presenter, the organizer or the like of the conference selects a conference to be convened from the conference list screen in FIG. 8, and instructs to convene the conference. The conference convening application which operates on the WEB browser 21 in the client terminal 10 requires the conference server apparatus 12 to convene the conference. The conference server 32 in the conference server apparatus 12 that receives the request for convening the conference creates a conference room (room) in XMPP.

Meanwhile, in the case where a password for convening is set for the conference information of the conference to be convened, the conference convening application which operates on the WEB browser 21 in the client terminal 10 requires the presenter, the organizer or the like of the conference to input the password for convening. Then, the conference convening application incorporates the password for convening into the request for convening the conference input by the presenter, the organizer or the like of the conference.

The presenter, a participant or the like of the conference, by selecting “Today's conferences” in the conference registration screen in FIG. 7, makes the WEB browser 21 in the client terminal 10 display a conference list screen shown in FIG. 8. The presenter, the participant or the like of the conference selects a conference to participate in from the conference list screen in FIG. 8, and instructs to participate in the conference. The conference convening application which operates on the WEB browser 21 in the client terminal 10 requires the conference server apparatus 12 to participate in the conference.

The conference server 32 in the conference server apparatus 12 that receives the request for participating in the conference causes the client terminal 10 that requires to participate in the conference to enter the XMPP conference room, thereby the client terminal participates in the conference.

Meanwhile, in the case where a password for participating is set for the conference information of the conference to participate in, the conference convening application which operates on the WEB browser 21 in the client terminal 10 requires the presenter, the participant or the like of the conference to input the password for participating. Then, the conference convening application incorporates the password for participating into the request for participating in the conference input by the presenter, the participant or the like of the conference.

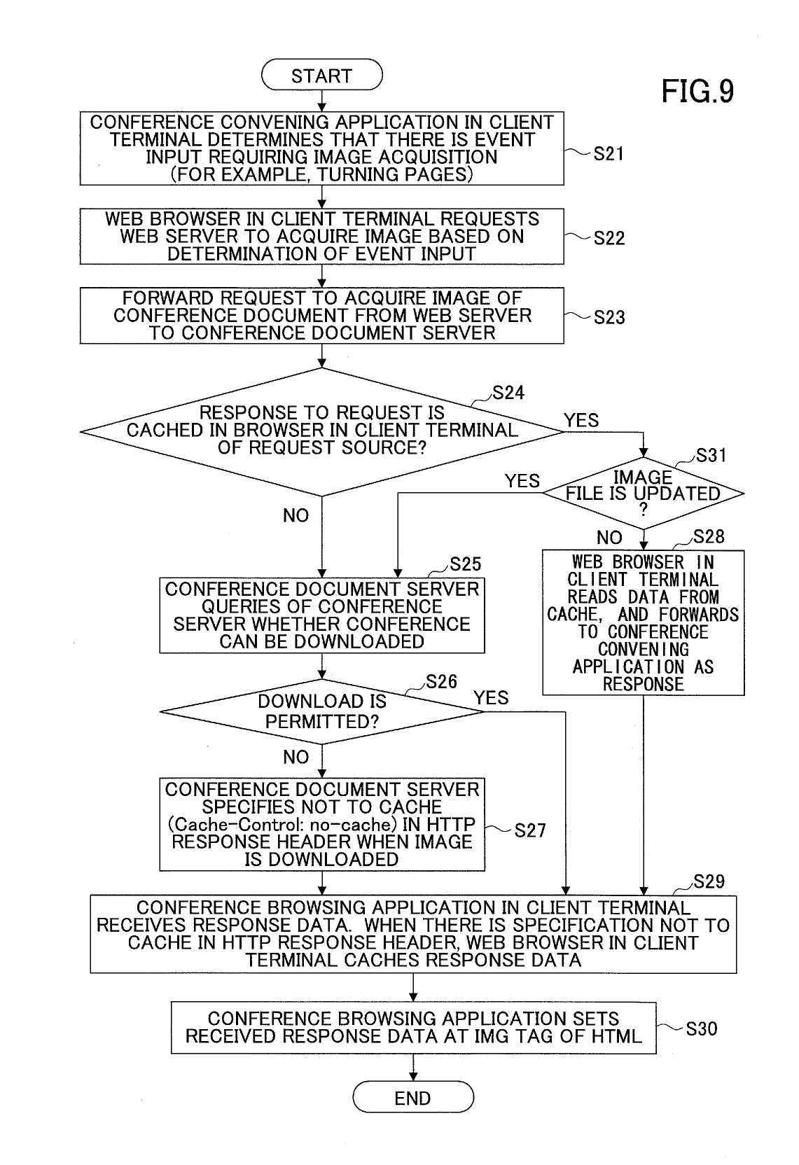

The client terminal 10 that participates in the conference receives an image file of a conference document from the conference server apparatus 12 according to a procedure illustrated in the flowchart shown in FIG. 9. FIG. 9 is a flowchart illustrating an example of a process of sending/receiving the image file of the conference document.

The client terminal 10 that participates in the conference receives, for example, an image file of the conference document corresponding to the first page of the conference document file from the conference server apparatus 12. Here, a process of the client terminal 10, which participates in the conference, receiving the image file of the conference document corresponding to the first page from the conference server apparatus 12 will be explained.

At step S21, the conference convening application that operates on the WEB browser 21 in the client terminal 10 which participates in the conference determines that a notice of the first page being an event input which requires an acquisition of the image file of the conference document is from the conference server apparatus 12. Meanwhile, the first page here is not limited to the first page of the conference document file. It only has to be a page of the conference document file displayed on the client terminal 10 of the presenter.

At step S22, the WEB browser 21 in the client terminal 10, based on a determination for the event input at step S21, requests the conference server apparatus 12 to acquire an image file of the conference document corresponding to the first page of the image file of the conference document. Meanwhile, the request at step S22 includes information indicating it is cached when the image file of the conference document, acquisition of which is requested, is cached in the WEB browser.

The image file of the conference document cached in the WEB browser 21 is, in addition to the image file of the conference document cached in the cache file storage unit 22, an image file of the conference document in a non-display state set at an IMG tag of an HTML file, as described below.

In the process of the client terminal 10, which participates in the conference, receiving the image file of the conference document corresponding to the first page from the conference server apparatus 12, information indicating that it is cached is not included since there is not a cached image file of the conference document in the WEB browser 21.

For the information indicating it is cached, in the case where a request to the WEB server 31 is a HTTP request, for example, a value of If-Modified-Since request field may be used.

In the case of not incorporating the information indicating it is cached, nothing is specified for the parameter of If-Modified-Since. On the contrary, in the case of incorporating the information indicating it is cached, a request, in which a date and time when the cached image file of the conference document is acquired is set in the parameter of If-Modified-Since in a header, is sent.

The process of the WEB server 31 proceeds to step S23, and a request for acquiring the image file of the conference document is forwarded to the conference document server 33. At step S24, the conference document server 33 in the conference server apparatus 12 receives from the WEB server 31 a request for acquiring the image file of the conference document corresponding to the first page of the image file of the conference document from the client terminal 10. The conference document server 33 determines whether the latest image file of the conference document which is requested to be acquired is cached in the WEB browser 21 based on whether the received request includes information indicating it is cached and based on whether there is an update in the image file of the conference document in the case where it is cached.

Meanwhile, here, since the received request does not include the information indicating that it is cached, it is determined that the image file of the conference document which is requested to be acquired at the WEB server 31 is not cached in the WEB browser 21.

When it is determined that the image file of the conference document which is requested to be acquired is not cached in the WEB browser 21 (NO), the process of the conference document server 33 proceeds to step S25. At step S25, the conference document server 33 inquires of the conference server 32 about a setting of “permission to download the conference document” of the conference information corresponding to the image file of the conference document which is requested to be acquired.

At step S26, the conference document server 33, based on the setting of “permission to download the conference document” of the conference information corresponding to the image file of the conference document which is requested to be acquired, determines whether a cache of the image file of the conference document in the cache file storage unit 22 is not permitted.

When the cache of the image file of the conference document in the cache file storage unit 22 is determined not to be permitted (NO), the process of the conference document server 33 proceeds to step S27.

The conference document server 33 performs a specification not to cache in a HTTP response header upon downloading the requested image file of the conference document (for example, Cache-Control: no-cache), and the process proceeds to step S29.

Meanwhile, at step S26, when it is determined that the cache of the image file of the conference document in the cache file storage unit 22 is permitted (YES), the process of the conference document server 33 skips step S27, and proceeds to step S29.

At step S29, the conference convening application which operates on the WEB browser 21 in the client terminal 10 receives a response to the request at step S22 from the conference server apparatus 12. When the specification not to cache is not performed in the HTTP response header, the WEB browser 21 caches a downloaded image file of the conference document in the cache file storage unit 22.

On the other hand, when the specification not to cache is performed in the HTTP response header, the WEB browser 21 does not cache the downloaded image file of the conference document in the cache file storage unit 22.

Meanwhile, since the image file of the conference document which is cached in the cache file storage unit 22 is written out in a folder for cache or the like in the HDD 508, it remains in the HDD 508 even after the conference.

At step S30, the conference convening application which operates on the WEB browser 21 in the client terminal 10 sets (allocates) the downloaded image file of the conference document at the IMG tag of the HTML file, as described later.

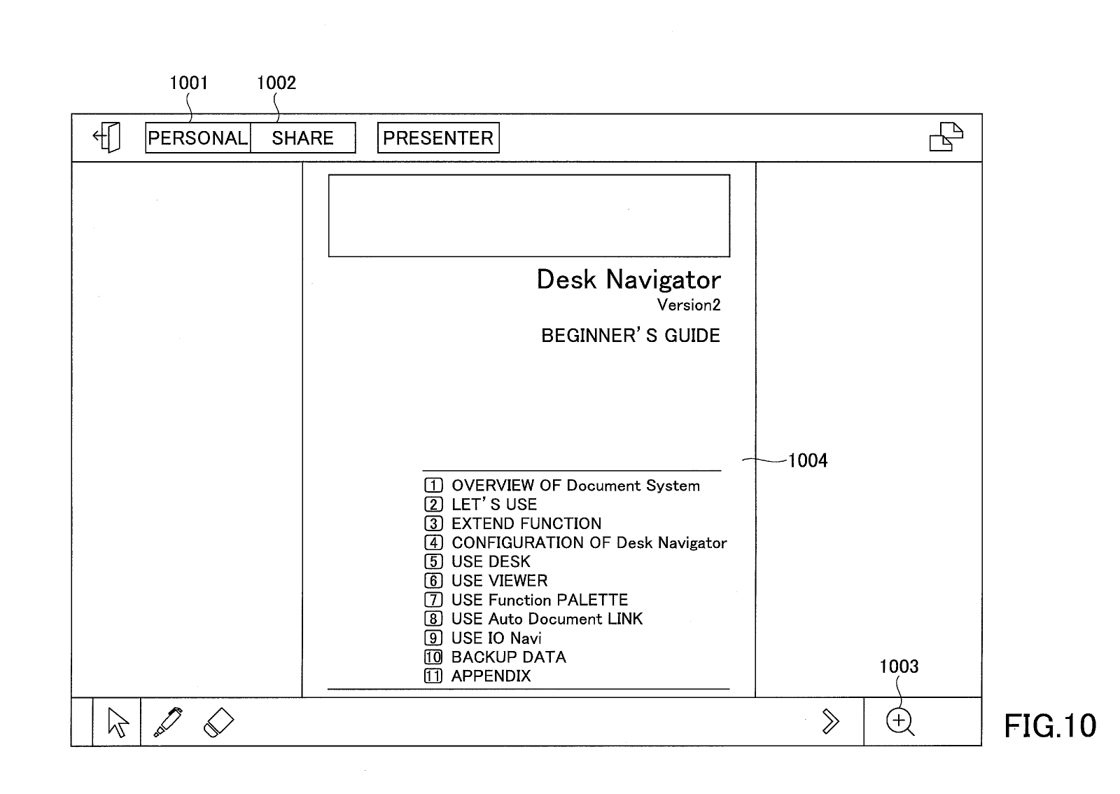

Meanwhile, since the image file of the conference document set at the IMG tag of the HTML file becomes unusable after the process of the WEB browser 21 ends, a leakage of the image file of the conference document is inhibited. The conference convening application which operates on the WEB browser 21 in the client terminal 10 displays the downloaded image file of the conference document in a conference screen as shown in FIG. 10.

FIG. 10 is a diagram illustrating an example of the conference screen. In the conference screen in FIG. 10, an image 1004 in the image file of the conference document downloaded from the conference server apparatus 12 is displayed. The conference screen in FIG. 10 includes a button 1002 for specifying a share mode in which the image 1004 is updated interlocked with a turning of a page and a button for specifying a personal mode in which a turning of a page can be made freely without interlocking with a presenter turning a page.

Moreover, the conference screen in FIG. 10 includes a button 1003 for performing an operation to enlarge or reduce the image 1004. The presenter, the participants or the like in the conference can browse the image 1004 in the image file of the conference document by the conference screen in FIG. 10.

Next, a process when the presenter of the conference operates the conference screen to turn a page will be explained with reference to FIG. 9. For example, the conference convening application which operates on the WEB browser 21 in the client terminal operated by the presenter, based on the presenter turning a page, gives notice of a display page of a conference document file to be displayed next to the conference server apparatus 12. The conference server apparatus 12 gives notice of the display page of the conference document file to be displayed next to all terminal devices 10 participating in the conference.

At step S21, the conference convening application which operates on the WEB browser 21 in the client terminal 10 participating in the conference determines that the notice of turning a page which is an event input in which an acquisition of the image file of the conference document is necessary is from the conference server apparatus 12. Meanwhile, the turning page, mentioned here, is not limited to turning page by page, but may be turning of plural pages.

At step S22, the WEB browser 21 in the client terminal 10, based on the determination for the event input at step S21, requests the conference server apparatus 12 to acquire an image file of a conference document corresponding to the display page of the conference document file to be displayed next. The request at step S22 includes, when the image file of the conference document, which requests the acquisition, is cached in the WEB browser, information indicating that it is cached.

As described above, the information indicating that it is cached, in the case of the HTTP request, for example, can use a date and time when the cached image file of the conference document is acquired set in a parameter of If-Modified-Since in a header.

The process of the WEB server 31 proceeds to step S23, and the request to acquire the image file of the conference document is forwarded to the conference document server 33. At step S24, the conference document server 33 in the conference server apparatus 12 receives from the WEB server 31 the request to acquire the image file of the conference document corresponding to the display page of the conference document file to be displayed next from the client terminal 10.

The conference document server 33 determines whether a latest image file of the conference document an acquisition of which is requested is cached in the WEB browser 21, based on whether the received request includes the information indicating that it is cached.

When the request includes the information indicating that it is cached, the conference document server 33 further determines (step S31), based on the date and time when the cached image file of the conference document is acquired, whether the image file of the conference document is updated after this date and time. When it is not updated (S31: NO), the conference document server 33 determines that the requested image file of the conference document is cached in the WEB browser 21, and does not perform a download of the requested image file of the conference document. The process proceeds to step S28. When it is updated (S31: YES), since the latest image file of the conference document is not cached, the process of the conference document server 33 proceeds to step S25. The conference document server 33 may return a response to the request to the client terminal 10 via the WEB server 31.

Meanwhile, when the requested image file of the conference document is cached in the WEB browser 21, the process of the WEB browser 21 in the client terminal 10 proceeds to step S28, and returns the image file of the conference document to the conference convening application as a response.

Following step S28, the process proceeds to step S29, and the conference convening application which operates on the WEB browser 21 in the client terminal 10 receives an image file of the conference document to be displayed next from the WEB browser 21 as a response. When the specification not to cache is not performed in the HTTP response header, the WEB browser 21 caches the image file of the conference document received as a response in the cache file storage unit 22.

On the other hand, when the specification not to cache is performed in the HTTP response header, the WEB browser 21 does not cache the image file of the conference document received as a response in the cache file storage unit 22.

At step S30, the conference convening application which operates on the WEB browser 21 in the client terminal 10 sets the image file of the conference document received as a response at the IMG tag of the HTML file, as described later.

On the other hand, at step S24, when the request does not include the information indicating that it is cached, the conference document server 33 determines that the requested image file of the conference document is not cached in the WEB browser 21.

When it is determined that the image file of the conference document an acquisition of which is requested is not cached in the WEB browser 21 (NO), the process of the conference document server 33 proceeds to step S25. Processes at step S25 and further are the same as the processes of receiving the image file of the conference document corresponding to the first page from the conference server apparatus 12, as described above, and the explanation will be omitted.

At step S28 in FIG. 9, when the image file of the conference document to be displayed next is cached in the WEB browser 21, an access is sped up by using the cached image file of the conference document. The WEB browser 21 is provided with a function of caching a downloaded file in a cache file storage unit 22 in order to speed up an access to the same file.

In the conference system 1 according to the present embodiment, in order to inhibit a leakage of information by the file cached in the cache file storage unit 22, an image file of a conference document that can be displayed only during the conference is set so as not to be cached in the cache file storage unit 22. According to the above processes, the conference system 1 is set so that an image file of the conference document does not remain in the HDD 508 or the like after convening the conference.

Moreover, in the conference system 1, at the conference server apparatus 12, the respective pages of the conference document file are converted into image files of a conference document, and the image files of the conference document is stored in the conference document DB. In the conference system 1, when an image of the conference document file is displayed, an image file of the conference document of a displayed page only has to be sent from the conference server apparatus 12 to the client terminal 10.

Accordingly, in the conference system 1 according to the present embodiment, at the start of the conference, a time until a first page can be displayed is reduced, compared with a conference system in which a whole of the conference document file is downloaded and a first page is displayed.

On the other hand, the conference system 1 needs to download an image file of the conference document of a displayed page from the conference server apparatus 12 to the client terminal 10 every time an event input which needs an image acquisition occurs. Accordingly, in the case where an operation to perform an enlarged/reduced display is conducted, in order to perform the enlarged/reduced display of the image of the image file of the conference document at a fast rate, the conference system 1 is designed as follows.

For example, the enlarged/reduced display of the image file of the conference document can be performed by changing a value of a CSS file by a JavaScript (Trademark Registered) file. However, when an enlargement factor becomes greater, the image becomes coarse, and cannot be dealt with by one image file of the conference document.

Therefore, in the conference system 1, at the timing when the enlargement factor becomes greater than a predetermined enlargement factor, the image file of the conference document for a standard display is switched to an image file of the conference document for an enlarged display. Moreover, in the conference system 1, at the timing when the enlargement factor becomes less than the predetermined enlargement factor, the image file of the conference document for the enlarged display is switched to the image file of the conference document for the standard display.

Meanwhile, in the conference system 1, if the download is performed from the conference server apparatus 12 to the client terminal 10, at the time of switching to the image file of the conference document for the standard display or for the enlarged display, the enlarged/reduced display cannot be performed smoothly.

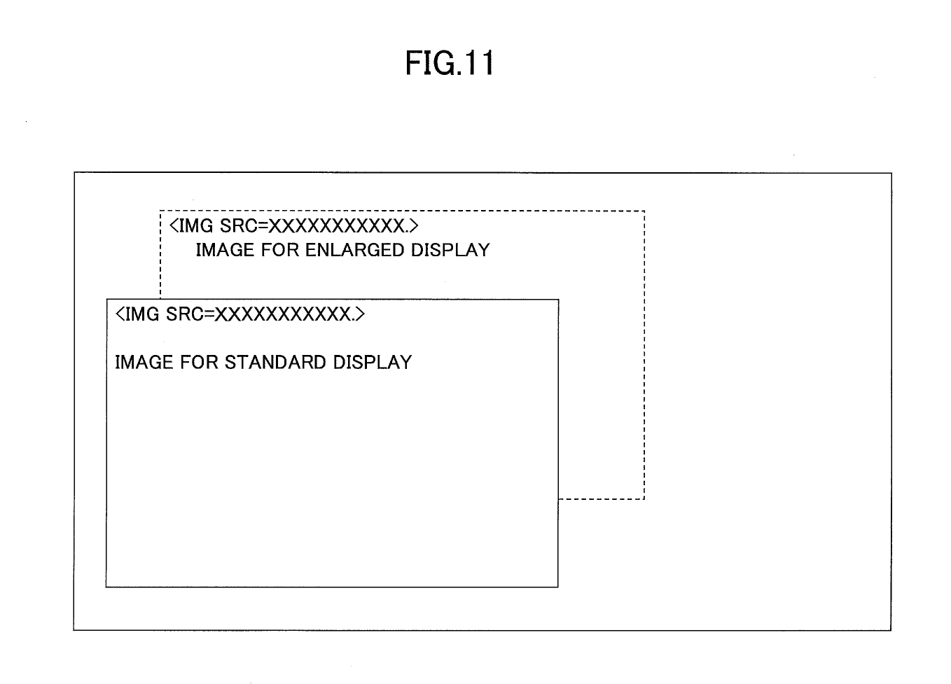

Therefore, in the conference system 1, an IMG tag for the standard display and an IMG tag for the enlarged display are prepared in the HTML file, and the image file of the conference document for the standard display and the image file of the conference document for the enlarged display are set so as to overlap with each other in the HTML file, as shown in FIG. 11.

FIG. 11 is a diagram illustrating an example of image files of a conference document for the standard display and for the enlarged display set respectively in the IMG tags in the HTML file. Meanwhile, the image files of the conference document for the standard display and for the enlarged display are transmitted from the conference server apparatus 12 to the client terminal 10 according to the procedure of the flowchart shown in FIG. 9.

For example, in the conference system 1, the image file of the conference document of the displayed page for the standard display is sent to the client terminal 10 first, and is set at the IMG tag for the standard display. Moreover, in the conference system 1, the image file of the conference document of the displayed page for the enlarged display is sent to the client terminal 10 by background asynchronous processing, and is set at the IMG tag for the enlarged display.

At first, the conference system 1 sets the IMG tag for the standard display to “display” and the IMG tag for the enlarged display to “non-display”. Then, in the conference system 1, at the timing when the enlargement factor becomes greater than a predetermined enlargement factor, the IMG tag for the standard display is switched to “non-display” and the IMG tag for the enlarged display is switched to “display”.

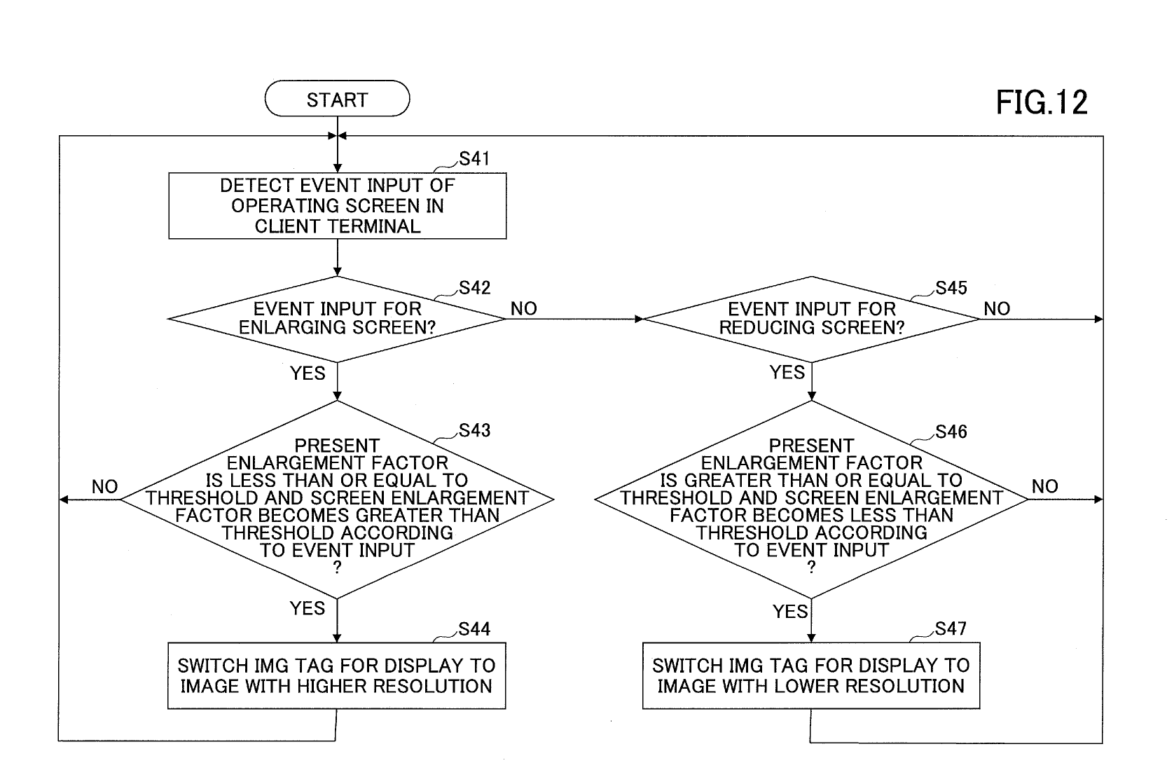

FIG. 12 is a flowchart illustrating an example of a process of the enlarged/reduced display for an image of the image file of conference document. At step S41, the conference convening application which operates on the WEB browser in the client terminal 10 detects an event input of a screen operation. The process proceeds to step S42, the conference convening application determines whether the detected event input is an enlargement of the screen.

When the detected event input is for the enlargement of the screen (YES), at step S43, the conference convening application determines whether the present enlargement factor is less than or equal to a threshold and the enlargement factor becomes greater than the threshold according to the event input. When it is determined that the present enlargement factor is less than or equal to the threshold and the enlargement factor becomes greater than the threshold according to the event input (YES), the process of the conference convening application proceeds to step S44, the IMG tag for display is switched from the IMG tag for the standard display to the IMG tag for the enlarged display, and the process returns to step S41.

The IMG tag of “non-display” can be specified, for example, by describing such as <img src=“XXXX . . . ” style=“display:none”>. Moreover, the IMG tag of “display” can be specified, for example, by describing such as <img src=“XXXX . . . ” style=“display:block”>.

At step S43, when it is not determined that the present enlargement factor is less than or equal to the threshold and the enlargement factor becomes greater than the threshold according to the event input, the conference convening application does not perform the process at step S44 and the process proceeds to step S41.

At step S42, when the detected event input is not for the enlargement of the screen (NO), the conference convening application determines whether the detected event input is a reduction of the screen in step S45. When the detected event input is the reduction of the screen (YES), at step S46, the conference convening application determines whether the present enlargement factor is greater than or equal to a threshold and the enlargement factor becomes less than the threshold according to the event input. When it is determined that the present enlargement factor is greater than or equal to the threshold and the enlargement factor becomes less than the threshold according to the event input (YES), the process of the conference convening application proceeds to step S47, the IMG tag for display is switched from the IMG tag for the enlarged display to the IMG tag for the standard display, and the process returns to step S41.

At step S46, when it is not determined that the present enlargement factor is greater than or equal to the threshold and the enlargement factor becomes less than the threshold according to the event input (NO), the conference convening application does not perform the process at step S47 and the process proceeds to step S41. Moreover, at step S45, when the detected event input is not the reduction of the screen (NO), the process of the conference convening application returns to step S41.

In this way, in the conference system 1 according to the present embodiment, the image files of the conference document for the standard display and for the enlarged display are set in the HTML file, and by switching between “display” and “non-display” a smooth enlarged/reduced display is realized.

Moreover, in the conference system 1, the image file of the conference document of the displayed page and the image file of the conference document of the next page are set at the IMG tags of the HTML file, and by switching between “display” and “non-display” a fast turning of a page can be also realized. The conference system 1 can deal with a fast turning to a previous page by setting the image file of the conference document of the previous page at the IMG tag of “non-display”. In the conference system 1, the image file of the conference document of the next page may be sent to the client terminal 10 and set at the IMG tag for next page by the background asynchronous process.

Meanwhile, in the procedure of the flowchart shown in FIG. 9, even when the image file of the conference document which is requested to the conference server apparatus 12 is cached in the WEB browser 21, a request including the information indicating that it is cached is also performed.

When the image file of the conference document which is requested to the conference server apparatus 12 is cached in the WEB browser 21, the conference system 1 may use the cached image file of the conference document without requesting to the conference server apparatus 12.

### SUMMARY

The conference system 1 according to the present embodiment can send an image file of a conference document corresponding to a displayed page from the conference server apparatus 12 to the client terminal 10. Moreover, the conference system 1 can set whether a cache of the image file of the conference document to be sent to the client terminal 10 in the cache file storage unit 22 is permitted. Accordingly, the conference system 1 of the present embodiment can save a conference document file easily, and a leakage of the conference document file can be inhibited.

Moreover, the conference system 1 according to the present embodiment can realize a smooth enlarged/reduced display or a fast display of turning pages by setting plural image files of the conference document in a HTML file and switching between “display” and “non-display”.

The present invention is not limited to the above specifically disclosed embodiments, and without departing from the scope of the present invention, various variations and modifications may be made. An information processing apparatus corresponds to the conference server apparatus 12. A storage unit that a terminal device has corresponds to the HDD 508. An image in a predetermined unit corresponds to the image file of the conference document. Information on the image in the predetermined unit before conversion corresponds to the conference document file.

A management unit recited in claims corresponds to the conference server 32. A provisioning unit corresponds to the conference document server 33. A registration request reception unit corresponds to the conference server 32. A display control unit corresponds to the conference convening application.

In the present embodiment, the configuration in which the conference server apparatus 12 includes the WEB server 31, the conference server 32, the conference document server 33 and the information storage unit 34 is explained. However, an other server apparatus may include them.

The conference system 1 in which the conference server apparatus 12 includes the WEB server 31, the conference server 32, the conference document server 33 and the information storage unit 34 is an example. It goes without saying that there are various examples for the system configuration depending on an intended use or purpose.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatus such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD COM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

Further, the present invention is not limited to these embodiments, but various variations and modifications may be made without departing from the scope of the present invention.

The present application is based on and claims the benefit of priority of Japanese Priority Application No. 2013-240517 filed on Nov. 21, 2013, the entire contents of which are hereby incorporated by reference.

What is claimed is:

1. An information processing apparatus connectable to one or more terminal devices via a network, comprising:
a management unit that associates information which is required to be displayed on a terminal device with a setting of whether the information is allowed to be stored in a storage unit included in the terminal device; and
a provisioning unit that adds to the information a specification indicating that the information is not allowed to be stored in the storage unit included in the terminal device and provides the information to the terminal device which requires the information, when the setting associated with the information to be displayed on the terminal device indicates that the information is not allowed to be stored in the storage unit included in the terminal device.

2. The information processing apparatus as claimed in claim 1, further comprising: a conversion unit that converts the information to be displayed on the terminal device into an image with a predetermined size to be displayed on the terminal device, wherein the provisioning unit adds to the information a specification indicating that the information is not allowed to be stored in the storage unit included in the terminal device and provides the image with the predetermined size converted from the information to be displayed to the terminal device which requires the image with the predetermined size, when the setting associated with the information before being converted into the image with the predetermined size indicates that the information is not allowed to be stored in the storage unit included in the terminal device.

3. The information processing apparatus as claimed in claim 2, wherein the conversion unit converts the information to be displayed on the terminal device into an image for a standard display and an image for an enlarged display with predetermined sizes to be displayed on the terminal device, and the provisioning unit adds to the information a specification indicating that the information is not allowed to be stored in the storage unit included in the terminal device and provides the image for the standard display and the image for the enlarged display with the predetermined sizes converted from the information to be displayed to the terminal device which requires the image for the standard display and the image for the enlarged display with the predetermined sizes, when the setting associated with the information before being converted into the image for the standard display and the image for the enlarged display with the predetermined sizes indicates that the information is not allowed to be stored in the storage unit included in the terminal device.

4. The information processing apparatus as claimed in claim 1, wherein the setting of whether the information is allowed to be stored in the storage unit included in the terminal device is a setting as to whether the information is allowed to be cached in a browser installed on the terminal device.

5. The information processing apparatus as claimed in claim 1, further comprising: a registration request reception unit that receives from the terminal device a request to register information including a specification of whether the information is allowed to be stored in the storage unit included in the terminal device, and instructs the management unit to associate the information to be displayed on the terminal device with a setting of whether the information is allowed to be stored in the storage unit included in the terminal device.

6. The information processing apparatus as claimed in claim 1, wherein the storage unit included in the terminal device is an auxiliary storage device.

7. An information provisioning method executed in an information processing apparatus connectable to one or more terminal devices via a network, comprising:
associating information which is required to be displayed on a terminal device with a setting of whether the information is allowed to be stored in a storage unit included in the terminal device; and
adding to the information a specification indicating that the information is not allowed to be stored in the storage unit included in the terminal device and providing the information to the terminal device which requires the information, when the setting associated with the information to be displayed on the terminal device indicates that the information is not allowed to be stored in the storage unit included in the terminal device.

8. An information display system in which an application installed on one or more terminal devices and an information processing apparatus are connected via a network, comprising:
a management unit that associates information which is required to be displayed on the application with a setting of whether the information is allowed to be stored in a storage unit included in a terminal device;
a provisioning unit that adds to the information a specification indicating that the information is not allowed to be stored in the storage unit included in the terminal device and provides the information to the application which requires the information, when the setting associated with the information to be displayed on the application indicates that the information is not allowed to be stored in the storage unit included in the terminal device; and
a display control unit that displays the provided information without storing the information in the storage unit included in the terminal device, when the information which specifies that the information is not allowed to be stored in the storage unit included in the terminal device is provided.

9. The information display system as claimed in claim 8, further comprising: a conversion unit that converts the information to be displayed on the application into an image with a predetermined size to be displayed on the application, wherein the provisioning unit adds to the information a specification indicating that the information is not allowed to be stored in the storage unit included in the terminal device and provides the image with the predetermined size converted from the information to be displayed to the application which requires the image with the predetermined size, when the setting associated with the information before being converted into the image with the predetermined size indicates that the information is not allowed to be stored in the storage unit included in the terminal device, and the display control unit switches between a display mode and a non-display mode of the provided image with the predetermined size.

10. The information display system as claimed in claim 9, wherein the conversion unit converts the information to be displayed on the application into an image for a standard display and an image for an enlarged display with predetermined sizes to be displayed on the application, the provisioning unit adds to the information a specification indicating that the information is not allowed to be stored in the storage unit included in the terminal device and provides the image for the standard display and the image for the enlarged display with the predetermined sizes converted from the information to be displayed to the application which requires the image for the standard display and the image for the enlarged display with the predetermined sizes, when the setting associated with the information before being converted into the image for the standard display and the image for the enlarged display with the predetermined sizes indicates that the information is not allowed to be stored in the storage unit included in the terminal device, and the display control unit switches between the display mode and the non-display mode of the provided image for the standard display and the provided image for the enlarged display with the predetermined sizes, respectively.

11. The information display system as claimed in claim 10, wherein when the display control unit receives, during the image for the standard display is displayed, an enlargement operation from a screen in an enlargement factor of less than or equal to a threshold to a screen in an enlargement factor of greater than the threshold, the display control unit switches the mode of the image for the standard display from the display mode to the non-display mode and switches the mode of the image for the enlarged display from the non-display mode to the display mode.

12. The information display system as claimed in claim 10, wherein when the display control unit receives, during the image for the enlarged display is displayed, a reduction operation from a screen in an enlargement factor of greater than or equal to a threshold to a screen in an enlargement factor of less than the threshold, the display control unit switches the mode of the image for the enlarged display from the display mode to the non-display mode and switches the mode of the image for the standard display from the non-display mode to the display mode.

13. The information display system as claimed in claim 9, wherein the display control unit allocates the respective provided images with the predetermined sizes at different tags of a HTML file, and switches between the display mode and the non-display mode at each of the tags.
